(19) United States
(12) Patent Application Publication
(10) Pub. No.: US 2020/0145193 A1
(43) Pub. Date: May 7, 2020

(54) DATA PROVIDING SYSTEM AND DATA PROVIDING METHOD THEREOF

(71) Applicant: Institute For Information Industry, Taipei (TW)

(72) Inventors: Po-Chih CHEN, New Taipei City (TW); Ming-Hung TSAI, Taipei City (TW)

(21) Appl. No.: 16/205,158

(22) Filed: Nov. 29, 2018

(30) Foreign Application Priority Data
Nov. 1, 2018 (TW) 107138822

(51) Int. Cl. H04L 9/06; G06F 21/64; G06F 21/62; G06Q 20/40

(52) U.S. Cl. CPC H04L 9/0637; H04L 9/0643; G06F 21/64; G06Q 2220/00; G06Q 20/401; H04L 2209/38; G06F 21/6254

(57) ABSTRACT

A data providing system includes a storage server and at least three electronic apparatuses. The storage server stores a plurality of historical data of several users, each of which includes a first voucher data and a first progress content corresponding to the first voucher data. The at least three electronic apparatuses include a main electronic apparatus and several secondary electronic apparatuses. The at least three electronic apparatuses perform verification between each pair of the electronic apparatuses according to a part of the progress content to determine whether each of the secondary electronic apparatuses corresponds to a first user of the storage server. When it is determined that the secondary electronic apparatus all correspond to the first user, the main electronic apparatus obtains the historical data of the first user from the storage server, and provides data corresponding to the first progress content of the first user to the first user.

### PRIORITY

This application claims priority to Taiwan Patent Application No. 107138822 filed on Nov. 1, 2018, which is hereby incorporated by reference in its entirety.

### FIELD

The present invention relates to a data providing system and a data providing method thereof. More particularly, the present invention relates to a data providing system and a data providing method thereof for providing data corresponding to study progress of a user.

### BACKGROUND

As the study contents become diversified in recent years, many educational courses have been developed commercially, especially cross-place and interdisciplinary educational ideas and courses (e.g., STEM education, which is an acronym for the four disciplines Science, Technology, Engineering and Mathematics, and which is an educational policy and course plan proposed for improving the scientific and technological competitiveness). The schools, enterprises and the teaching aid dealers provide their students, employees and customers with various educational courses. Generally speaking, the study resources may be distributed in various service places (e.g., schools, cram schools, or home tutoring) and various content carriers (e.g., teaching aids, or reference books). However, because each individual has his or her own study history or experience, it is impossible for the teaching aid providers (e.g., teachers, or teaching aid dealers) to quickly and correctly track the actual study conditions and progress of different students to effectively integrate or design optimized courses for individuals in a cross-place and interdisciplinary way, and various systems must be built and integrated at a great cost.

Additionally, even if the study progress and contents of different users can be tracked, it is difficult to confirm identities of the users because the users may often use different terminal equipment or electronic apparatuses in different places. In such cases, the teaching aid providers are unwilling to release materials of the users because of concerns of data security and privacy right (e.g., impersonated attendance, or stealing other people's study materials, etc.).

Accordingly, an urgent need exists in the art to provide a technology capable of confirming a user's identity and providing data corresponding to the study progress of the user.

### SUMMARY

Provided is a data providing system. The data providing system can comprise a storage server and at least three electronic apparatuses. The storage server comprises a plurality of storage nodes. Each of the storage nodes stores a plurality of historical data of one user, and each of the historical data comprises a first voucher data and a first progress content corresponding to the first voucher data. The at least three electronic apparatuses include a main electronic apparatus and a plurality of secondary electronic apparatuses, wherein the at least three electronic apparatuses are connected to the storage server via a network. The at least three electronic apparatuses perform a one-to-one verification between each pair of the electronic apparatuses according to a portion of progress content of each of the electronic apparatuses to determine whether each of the secondary electronic apparatuses corresponds to a first user of the storage server, wherein each of the portions of the progress content corresponds to a portion of the first progress content of the first user. When the at least three electronic apparatuses determine that all of the secondary electronic apparatuses correspond to the first user of the storage server, the main electronic apparatus obtains the historical data of the first user from the storage server, and provides a data corresponding to the first progress content of the first user to the first user.

Also provided is a data providing method adapted for use in a data providing system. The data providing system can comprise a storage server and at least three electronic apparatuses. The at least three electronic apparatuses include a main electronic apparatus and a plurality of secondary electronic apparatuses. The at least three electronic apparatuses are connected to the storage server via a network. The storage server comprises a plurality of storage nodes. Each of the storage nodes stores a plurality of historical data of one user, and each of the historical data comprises a first voucher data and a first progress content corresponding to the first voucher data. The data providing method comprises the following steps: performing, by the at least three electronic apparatuses, a one-to-one verification between each pair of the electronic apparatuses according to a portion of progress content of each of the electronic apparatuses to determine whether each of the secondary electronic apparatuses corresponds to a first user of the storage server, wherein each of the portions of the progress content corresponds to a portion of the first progress content of the first user; and obtaining, by the main electronic apparatus, the historical data of the first user from the storage server when the at least three electronic apparatuses determines that all of the secondary electronic apparatuses correspond to the first user of the storage server, and providing, by the main electronic apparatus, a data corresponding to the first progress content of the first user to the first user.

As can be known from the above description, the data providing technology (at least including the data providing system and the data providing method) verifies the historical study data of a user via at least three electronic apparatuses to confirm the identity of the user. Then, the main electronic apparatus obtains the historical study data corresponding to the user from the storage server, and provides the data of the corresponding progress content to the user. Through the aforesaid operations, the identity of the user can be surely verified to protect data security and privacy right of the user. Furthermore, through the aforementioned operations, the actual study conditions and the study progress of the user can be tracked to adaptively provide the user with cross-place and interdisciplinary study data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic architectural view of a data providing system according to a first embodiment;

FIG. 2 depicts a schematic view of an operational procedure of the data providing system; and

FIG. 3 depicts a flowchart diagram of a data providing method according to a second embodiment.

### DETAILED DESCRIPTION

In the following description, the present invention will be explained with reference to several example embodiments thereof. However, these example embodiments are not intended to limit the present invention to any specific examples, embodiments, operations, environments, applications, structures, procedures or steps described in these example embodiments.

In the attached drawings, elements not directly related to the present invention are omitted from depiction. In the attached drawings, dimensional relationships among individual elements are illustrated only for ease of understanding, but not to limit the actual scale in the present invention. Unless stated particularly, identical (or similar) reference numerals correspond to identical (or similar) elements in the following description.

For ease of understanding, a data providing system related to teaching will be described as an example. Specifically in this exemplary example, how the data providing system verifies the identity of a user studying in a place and provides study contents suitable for the user according to the study history/progress of the user will be described. However, the data providing system is not limited to the aforesaid situation or teaching-related data, and how the data providing system operates in other situations should be appreciated by those of ordinary skill in the art from the following description.

Furthermore, with rapid development of the Internet-of-Things (IoT), use of portable electronic apparatuses becomes increasingly popular, and almost everyone carries about two or more electronic apparatuses (e.g., wearable apparatuses, IoT apparatuses, mobile apparatuses, etc.). The technology provided by the invention enables the user, via the electronic apparatuses carried about by the users, record the study history without manually recording by the user, completely track various study contents that are studied in different places, integrate and exchange data from different sources, and upload or record the study data of users to track current study conditions of each user at any time and at any place. In case of a cross-place course, a mechanism of data verification between each pair of the electronic apparatuses of at least three electronic apparatuses and intelligent content matching in a cloud database can be utilized to provide a personalized educational course (e.g., STEM education), thus improving the study effect of the users.

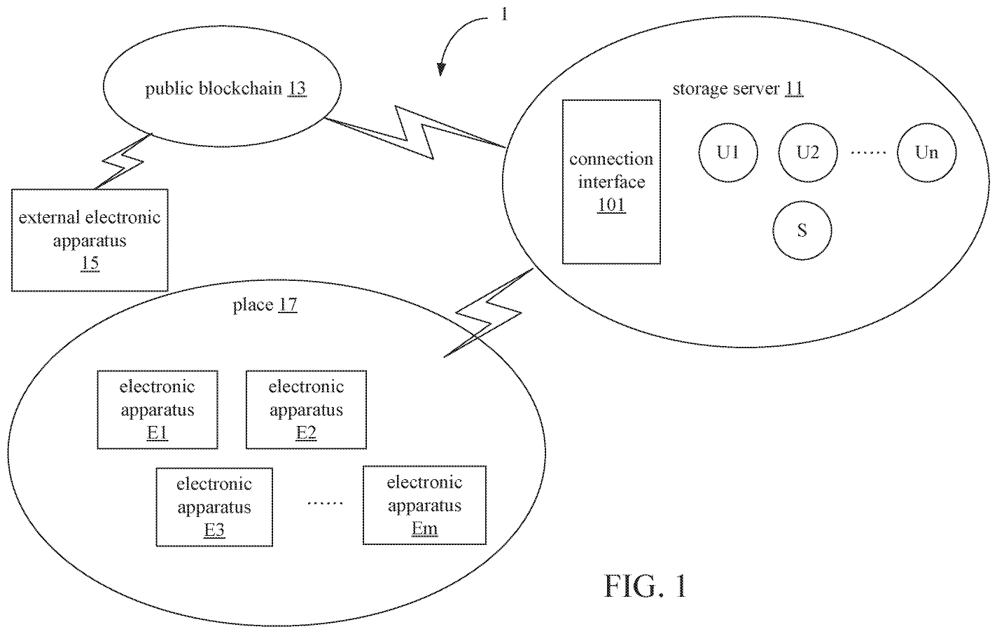

FIG. 1 illustrates a data providing system 1 according to some embodiments of the present invention. What shown in FIG. 1 is only intended to illustrate embodiments of the present invention but not to limit the present invention. Referring to FIG. 1, the data providing system 1 may comprise a storage server 11 and at least three electronic apparatuses (e.g., an electronic apparatus E1, an electronic apparatus E2, an electronic apparatus E3, and an electronic apparatus Em, where m is a positive integer greater than 3), and the at least three electronic apparatuses are connected to the storage server 11 via a network.

The storage server 11 may consist of one or more computer apparatuses, and may be configured to store data. Each of the computer apparatuses may comprise a first-level memory (a.k.a. a main memory or an internal memory), a second-level memory (a.k.a. an external memory or an auxiliary memory). For example, the second-level memory may be but not limited to a hard disc drive, a compact disk (CD) or the like. In addition to the first-level memory and the second-level memory, each of the computer apparatuses may further comprise a third-level memory, i.e., a storage device (e.g., a mobile disc) directly pluggable into or removable from the computer apparatus. More than one computer apparatus may be connected with each other to jointly store data of the storage server 11.

Each of the at least three electronic apparatuses at least comprises a processor, a microprocessor or a microcontroller configured to execute various basic operation programs. The microprocessor or microcontroller is a kind of special programmable integrated circuit (IC), which has the capability of operations, storage, input/output or the like and can receive and process various codes/instructions to perform various logic operations and arithmetic operations and output corresponding operation results. In addition to the processor, microprocessor or microcontroller, each of the electronic apparatuses may further comprise other elements, for example but not limited to, output elements, networking elements or the like. Each of the electronic apparatuses may be any of various computer apparatuses having the capability of computing, storage, communication, networking or the like, for example but not limited to, portable computers, IoT apparatuses, wearable apparatuses, mobile apparatuses or the like.

For convenience of description, it is assumed in the first embodiment of the present invention that the at least three electronic apparatuses include a main electronic apparatus and a plurality of secondary electronic apparatuses in the data providing system 1. It shall be appreciated that, the main electronic apparatus may be one of the electronic apparatuses that has stronger operational capacity, and the secondary electronic apparatuses may be a plurality of wearable apparatuses, mobile apparatuses, IoT apparatuses or the like that are carried about by a plurality of users. For example, a teaching aid providing device in a place may be used as the main electronic apparatus for initiating verification among three parties and data providing. Furthermore, because the electronic apparatus carried about by a user may vary each time the user takes a lesson, verification of identity of the electronic apparatus currently used by the user shall be made by the main apparatus to avoid impersonated attendance so as to achieve correct and impartial data protection. A detailed verification method will be described later.

In this embodiment, the storage server 11 stores a plurality of user accounts which correspond to historical study data of the individual users respectively. Specifically, the storage server 11 has a plurality of storage nodes U1, U2, Un, where n is a positive integer greater than 2. Each of the storage nodes U1, U2, Un stores a plurality of historical data of a user respectively. Each of the plurality of historical data comprises a first voucher data and a first progress content corresponding to the first voucher data. It shall be noted that, each of the storage nodes may be a personal account to store all historical study data of a user, the historical data may be historical study data corresponding to each study of the user, and the first voucher data may be information related to textbook contents, e.g., a token of the textbook, a teaching aid provider, an API token or the like. The first progress content records a progress (e.g., a time axis, a performance score) of the textbook contents corresponding to the user. The first progress content may also comprise the user's performance with respect to the textbook contents or courses. Details of contents of the historical data will be described later.

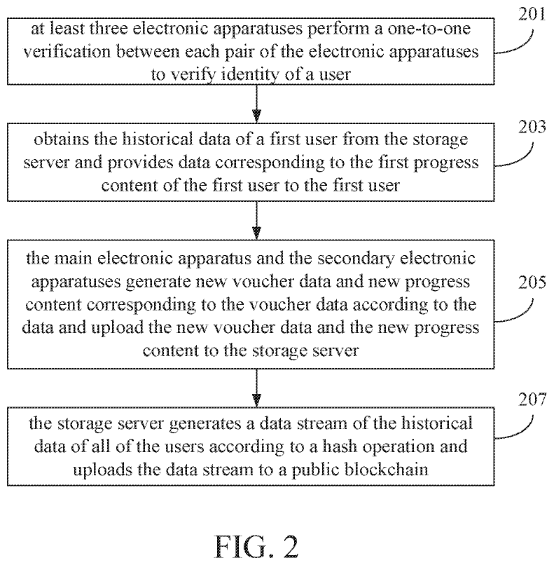

For ease of understanding, an operational procedure of the data providing system 1 will be described with reference to a schematic view first. FIG. 2 depicts a schematic view of an operational procedure of the data providing system 1. What depicted in FIG. 2 is only intended to illustrate embodiments of the present invention but not to limit the present invention. Referring to FIGS. 1 to 2, at least three electronic apparatuses (including a main electronic apparatus and a plurality of secondary electronic apparatuses) perform a one-to-one verification between each pair of the electronic apparatuses to verify identity of a user (Operation 201). Then, the main electronic apparatus obtains the historical data of a first user from the storage server 11 and provides data corresponding to the first progress content of the first user to the first user (Operation 203). Next, the main electronic apparatus and the secondary electronic apparatuses generate new voucher data and new progress content corresponding to the voucher data according to the data corresponding to the first progress content of the first user and upload the new voucher data and the new progress content to the storage server 11 (Operation 205). Finally, the storage server 11 generates a data stream of the historical data of all of the users according to a hash operation and uploads the data stream to a public blockchain 13 (Operation 207).

In terms of details of the verification, this embodiment uses the main electronic apparatus to verify a portion of progress content of the secondary electronic apparatuses (e.g., records related to the user's study on some previous day). When the main electronic apparatus determines that all of the secondary electronic apparatuses correspond to a same user, identity of the user can be confirmed. Specifically, the at least three electronic apparatuses perform a one-to-one verification between each pair of the electronic apparatuses according to a portion of progress content of each of the electronic apparatuses to determine whether each of the secondary electronic apparatuses corresponds to a first user of the storage server, wherein each of the portions of the progress content corresponds to a portion of the first progress content of the first user. It shall be noted that, the main electronic apparatus (e.g., the teaching aid providing device in the place) may have a plurality of first progress contents of the user (e.g., a plurality of latest historical study data of the user) stored in itself, or may obtain the first progress contents from an administrator storage node S in the storage server 11.

In some embodiments, the secondary electronic apparatuses have limited storage spaces, so the portion of the progress content of each of the secondary electronic apparatuses is obtained from the storage node corresponding to the first user in the storage server 11. In some embodiments, each of the one-to-one verifications is implemented by a cryptographic hash function algorithm (e.g., Secure Hash Algorithm 2 (SHA-2)).

Take the three electronic apparatuses E1, E2 and E3 of FIG. 1 as an example, and it is assumed that the place 17 is a classroom, the electronic apparatus E1 is a teaching aid providing device (i.e., the main electronic apparatus) in the place, and the electronic apparatuses E2 and E3 are wearable apparatuses of a user A (i.e., the secondary electronic apparatuses). When the user A is in the place where the electronic apparatus E1 is located, the electronic apparatuses E2 and E3 obtain the latest portion of progress content from a storage node corresponding to the user A in the storage server 11. Then, the main electronic apparatus E1 performs a one-to-one verification on the progress contents of the secondary electronic apparatus E2 and the secondary electronic apparatus E3, and confirm whether the progress content of each of the secondary electronic apparatuses is true by exchanging a parameter (e.g., a hash table) of encrypted progress contents with the secondary electronic apparatus E2 and the secondary electronic apparatus E3, and decrypting the parameter. If the verification is successful, the main electronic apparatus E1 can determine that all of the secondary electronic apparatuses E2, E3 correspond to the user A. Furthermore, the place 17 may also be a school, a cram school, an enterprise's office, or an open interaction space for studying. The secondary electronic apparatuses E2 and E3 may each be a smart phone, a smart bracelet, a smart garment, a pair of smart glasses, smart pearls, or similar networking wearable apparatuses.

It shall be noted that, if the electronic apparatus E2 fails to directly connect to the main electronic apparatus E1 for verification due to failure of signal receiving or due to power shortage, the verification on the electronic apparatus E2 may also be accomplished by another electronic apparatus (e.g., the electronic apparatus E3 connected to the main electronic apparatus E1) adjacent to the electronic apparatus E2 and already connected to the main electronic apparatus E1. It shall be noted that, the present invention has no limitation on the approach of verification, and any encryption verification approach that is known to those of ordinary skill in the art can be applied in the present invention. Furthermore, the encrypted contents are not limited to the progress content, but may also include related parameters such as machine codes of the electronic apparatuses and users' keys.

Next, when the at least three electronic apparatuses E1, E2 and E3 determine that all of the secondary electronic apparatuses (e.g., the electronic apparatuses E2 and E3 of the first user) correspond to the first user of the storage server 11, the main electronic apparatus E1 obtains the historical data of the first user from the storage server 11 and provides data corresponding to the first progress content of the first user to the first user. For example, the main electronic apparatus E1 may obtain the historical data of the first user from the storage server 11 according to an account key provided by the electronic apparatuses E2 and E3. In some embodiments, the data corresponding to the first progress content of the first user is related to teaching. It shall be noted that, depending on settings of the teaching aid providing device in the place, the data provided by the main electronic apparatus E1 to the first user may comprise only the progress content (i.e., the teaching progress), or the main electronic apparatus E1 may provide both the progress content and the study textbook (e.g., the textbook for the next stage) to the first user according to the first voucher data (information related to the textbook content). In some embodiments, the main electronic apparatus E1 may also update the study textbook from an external content system (e.g., an STEM educational system) to update the study content.

After the first user has finished studying the study textbook, the main electronic apparatus E1 and the secondary electronic apparatuses E2, E3 transmit data related to the current study back to the corresponding storage node in the storage server 11 to update the storage contents in real time. For example, at least one of the secondary electronic apparatuses E2, E3 generates new voucher data and new progress content corresponding to the new voucher data, and transmits the new voucher data and the new progress content corresponding to the new voucher data to the storage node corresponding to the first user. Furthermore, the main electronic apparatus E1 generates new voucher data and new progress content corresponding to the new voucher data from the data provided as described above, and transmits the new voucher data and the new progress content corresponding to the new voucher data to the administrator storage node S.

Additionally, another problem to be solved by the present invention will be described as follows. According to the general knowledge, data verified by a public blockchain has public credibility. However, in an IoT environment, uploading data to a public blockchain piece by piece is costly (e.g., a miner fee for uploading to blockchain shall be paid for each piece of data), and because of the low computing capability of IoT apparatuses, the IoT apparatuses not necessarily have the ability to upload data to the public blockchain. Therefore, the aforesaid problem has to be solved when the blockchain is applied to the IoT.

The present invention also provides a technology of uploading the historical study data to a public blockchain. Specifically, the data may be stored into the storage server 11 in the manner of a private chain before being uploaded to the public blockchain. Before the data is stored into the storage server 11, identity of the user is verified via at least three electronic apparatuses in the way of on-to-one verification as described above. Then only when the data collected reaches a certain amount or at regular intervals, the data stored in the storage server 11 is uploaded to the public blockchain 13, thus solving the problem occurred when applying the blockchain to the IoT. Therefore, in some embodiments, the storage server 11 may connect to a public blockchain 13, generates a data stream from the historical data of all of the users according to a hash operation when the data collected reaches a certain amount or at regular intervals, and uploads the data stream to the public blockchain 13.

Because the historical study data of the users have commercial and research values, service providers or related business providers may be allowed to purchase the data stored in the storage server 11 under the promise that the users agree with this in some embodiments. Specifically, the storage server 11 may have a connection interface 101 for connecting an external electronic apparatus 15 (a purchaser) which proposes a data purchase request, wherein the data purchase request corresponds to the historical data of the first user. The storage server 11 may verify the data stream on the public blockchain 13 according to the historical data of the first user corresponding to the data purchase request and the hash operation to confirm that the historical data of the first user has not been modified.

In some embodiments, when the storage server 11 receives the data purchase request, the storage server 11 further transmits the data purchase request to the electronic apparatus (e.g., the electronic apparatus E2 and/or the electronic apparatus E3) corresponding to the first user, and the electronic apparatus may receive from the first user an message indicating whether the first user agrees to the data purchase request and transmits the message to the storage server 11. In some embodiments, to avoid disclosure of the user's identity, the storage server 11 may perform a data de-identification processing on the historical data corresponding to the first user before providing the historical data to the external electronic apparatus 15.

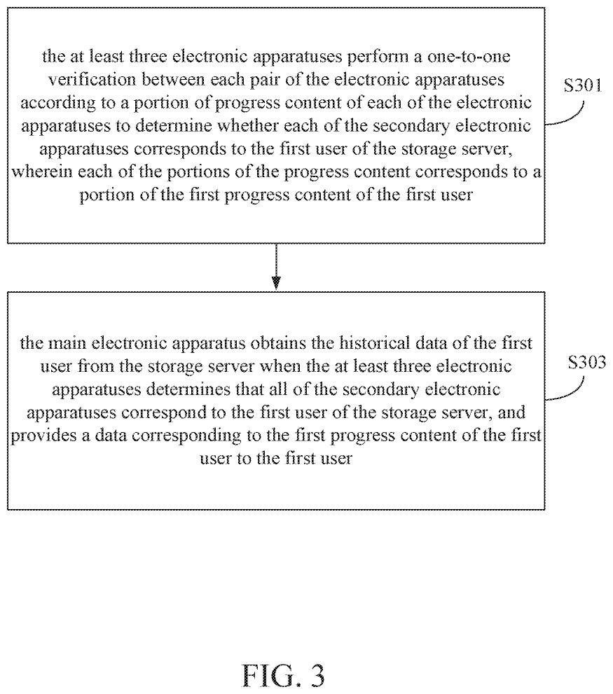

A second embodiment of the present invention is a data providing method. The data providing method is adapted for use in the data providing system 1 described in the first embodiment. The data providing system 1 comprises a storage server and at least three electronic apparatuses. The at least three electronic apparatuses include a main electronic apparatus and a plurality of secondary electronic apparatuses, and the at least three electronic apparatuses are connected to the storage server via a network. The storage server comprises a plurality of storage nodes, and each of the storage nodes stores a plurality of historical data of one user. Each of the historical data includes a first voucher data and a first progress content corresponding to the first voucher data. FIG. 3 depicts a flowchart diagram of the data providing method according to the second embodiment. What depicted in FIG. 3 is only intended to illustrate embodiments of the present invention, but not to limit the present invention.

As depicted in FIG. 3, the data providing method provides data to a first user through steps S301 to S303. In the step S301, the at least three electronic apparatuses perform a one-to-one verification between each pair of the electronic apparatuses according to a portion of progress content of each of the electronic apparatuses to determine whether each of the secondary electronic apparatuses corresponds to the first user of the storage server, wherein each of the portions of the progress content corresponds to a portion of the first progress content of the first user. Then in the step S303, the main electronic apparatus obtains the historical data of the first user from the storage server when the at least three electronic apparatuses determines that all of the secondary electronic apparatuses correspond to the first user of the storage server, and provides a data corresponding to the first progress content of the first user to the first user.

In some embodiments, the data providing method further comprises the following step in addition to the steps S301 and S303: obtaining, by each of the secondary electronic apparatuses, the portion of the progress content from the storage node corresponding to the first user of the storage server.

In some embodiments, each of the one-to-one verifications is implemented by a cryptographic hash function algorithm.

In some embodiments, the data corresponding to the first progress content of the first user is related to teaching.

In some embodiments, the data providing method further comprises the following steps performed by at least one of the secondary electronic apparatuses in addition to the steps S301 and S303: generating, after receiving the data corresponding to the first progress content of the first user, a second voucher data and a second progress content corresponding to the second voucher according to the data; and storing the second voucher data and the second progress content corresponding to the second voucher data to the storage node of the first user.

In some embodiments, the data providing method further comprises the following steps performed by the main electronic apparatus: generating, after generating the data corresponding to the first progress content of the first user, a second voucher data and a second progress content corresponding to the second voucher according to the data; and storing the second voucher data and the second progress content corresponding to the second voucher data to an administrator storage node.

In some embodiments, the storage server is further connected to a public blockchain, and the data providing method further comprises the following step performed by the storage server: generating a data stream of the historical data of all of the users according to a hash operation, and uploading the data stream to the public blockchain.

In some embodiments, the storage server further comprises a connection interface for connecting an external electronic apparatus which proposes a data purchase request, the data purchase request corresponds to the historical data of the first user, and the data providing method further comprises the following step: verifying, by the storage server, the data stream on the public blockchain according to the historical data of the first user corresponding to the data purchase request and the hash operation to confirm that the historical data of the first user has not been modified.

In some embodiments, the data providing method further comprises the following steps: transmitting, by the storage server when receiving the data purchase request, the data purchase request to the electronic apparatus corresponding to the first user; and receiving, by the electronic apparatus corresponding to the first user, a message indicating whether the first user agrees to the data purchase request and transmitting the message to the storage server.

In some embodiments, the data providing method further comprises the following step performed by the storage server: performing a data de-identification processing on the historical data corresponding to the first user, and providing the de-identified data to the external electronic apparatus.

In addition to the aforesaid steps, the data providing method described in the second embodiment can also comprise other steps corresponding to all of the aforesaid implementations of the data providing system 1 described in the first embodiment. Because these other steps can be known by those of ordinary skill in the art upon reviewing the above description of the data providing system 1 described in the first embodiment, they will not be further described herein.

It shall be appreciated that, in the specification and the claims of the present invention, some words (including: the user, the progress content, and the voucher data) are preceded by a term “first” or “second”, and these terms “first” and “second” are only used to distinguish different words from each other.

According to the above descriptions, the data providing technology (at least including the data providing system and the data providing method) of the present invention verifies the historical study data of a user via at least three electronic apparatuses to confirm the identity of the user. Then, the main electronic apparatus obtains the historical study data corresponding to the user from the storage server, and provides the data of the corresponding progress content to the user. Through the aforesaid operations, the identity of the user in a place can be surely verified to protect data security and privacy right of the user. Also through the aforesaid operations, the actual study conditions and the study progress of the user can be tracked to adaptively provide the user with cross-place and interdisciplinary study data. Furthermore, in a data providing system of the present invention, the data stored in the storage server 11 is uploaded to a public blockchain only when the data collected reaches a certain amount or at regular intervals, thus solving the problem occurred when applying the blockchain to the IoT.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data providing system, comprising:
a storage server, comprising a plurality of storage nodes, each of the storage nodes storing a plurality of historical data of one user, each of the historical data including a first voucher data and a first progress content corresponding to the first voucher data; and
at least three electronic apparatuses, including a main electronic apparatus and a plurality of secondary electronic apparatuses, wherein the at least three electronic apparatuses are connected to the storage server via a network;
wherein:
the at least three electronic apparatuses perform a one-to-one verification between each pair of the electronic apparatuses according to a portion of progress content of each of the electronic apparatuses to determine whether each of the secondary electronic apparatuses corresponds to a first user of the storage server, wherein each of the portions of the progress content corresponds to a portion of the first progress content of the first user; and
when the at least three electronic apparatuses determine that all of the secondary electronic apparatuses correspond to the first user of the storage server, the main electronic apparatus obtains the historical data of the first user from the storage server, and provides a data corresponding to the first progress content of the first user to the first user.

2. The data providing system of claim 1, wherein the portion of the progress content of each of the secondary electronic apparatuses is obtained from the storage node corresponding to the first user of the storage server.

3. The data providing system of claim 1, wherein each of the one-to-one verifications is implemented by a cryptographic hash function algorithm.

4. The data providing system of claim 1, wherein the data corresponding to the first progress content of the first user is related to teaching.

5. The data providing system of claim 1, wherein at least one of the secondary electronic apparatuses performs the following operations:
after receiving the data corresponding to the first progress content of the first user, generating a second voucher data and a second progress content corresponding to the second voucher according to the data; and
storing the second voucher data and the second progress content corresponding to the second voucher data to the storage node of the first user.

6. The data providing system of claim 1, wherein the main electronic apparatus performs the following operations:
after generating the data corresponding to the first progress content of the first user, generating a second voucher data and a second progress content corresponding to the second voucher according to the data; and
storing the second voucher data and the second progress content corresponding to the second voucher data to an administrator storage node.

7. The data providing system of claim 1, wherein the storage server is further connected to a public blockchain, generates a data stream of the historical data of all of the users according to a hash operation, and uploads the data stream to the public blockchain.

8. The data providing system of claim 7, wherein the storage server further comprises a connection interface for connecting an external electronic apparatus which proposes a data purchase request corresponding to the historical data of the first user, and the storage server is further configured to verify the data stream on the public blockchain according to the historical data of the first user corresponding to the data purchase request and the hash operation to confirm that the historical data of the first user has not been modified.

9. The data providing system of claim 8, wherein when the storage server receives the data purchase request, the storage server transmits the data purchase request to the electronic apparatus corresponding to the first user, and the electronic apparatus receives an message indicating whether the first user agrees to the data purchase request and transmits the message to the storage server.

10. The data providing system of claim 8, wherein the storage server further performs a data de-identification processing on the historical data corresponding to the first user, and provides the de-identified data to the external electronic apparatus.

11. A data providing method, being adapted for use in a data providing system, the data providing system comprising a storage server and at least three electronic apparatuses, the at least three electronic apparatuses including a main electronic apparatus and a plurality of secondary electronic apparatuses, the at least three electronic apparatuses being connected to the storage server via a network, the storage server comprising a plurality of storage nodes, each of the storage nodes storing a plurality of historical data of one user, each of the historical data including a first voucher data and a first progress content corresponding to the first voucher data, and the data providing method comprising:
performing, by the at least three electronic apparatuses, a one-to-one verification between each pair of the electronic apparatuses according to a portion of progress content of each of the electronic apparatuses to determine whether each of the secondary electronic apparatuses corresponds to a first user of the storage server, wherein each of the portions of the progress content corresponds to a portion of the first progress content of the first user; and
obtaining, by the main electronic apparatus, the historical data of the first user from the storage server when the at least three electronic apparatuses determines that all of the secondary electronic apparatuses correspond to the first user of the storage server, and providing, by the main electronic apparatus, a data corresponding to the first progress content of the first user to the first user.

12. The data providing method of claim 11, wherein the data providing method further comprises:
obtaining, by each of the secondary electronic apparatuses, the portion of the progress content from the storage node corresponding to the first user of the storage server.

13. The data providing method of claim 11, wherein each of the one-to-one verifications is implemented by a cryptographic hash function algorithm.

14. The data providing method of claim 11, wherein the data corresponding to the first progress content of the first user is related to teaching.

15. The data providing method of claim 11, wherein the data providing method further comprises the following steps performed by at least one of the secondary electronic apparatuses:
generating, after receiving the data corresponding to the first progress content of the first user, a second voucher data and a second progress content corresponding to the second voucher according to the data; and
storing the second voucher data and the second progress content corresponding to the second voucher data to the storage node of the first user.

16. The data providing method of claim 11, wherein the data providing method further comprises the following steps performed by the main electronic apparatus:
generating, after generating the data corresponding to the first progress content of the first user, a second voucher data and a second progress content corresponding to the second voucher according to the data; and
storing the second voucher data and the second progress content corresponding to the second voucher data to an administrator storage node.

17. The data providing method of claim 11, wherein the storage server is further connected to a public blockchain, and the data providing method further comprises the following step performed by the storage server:
generating a data stream of the historical data of all of the users according to a hash operation, and uploading the data stream to the public blockchain.

18. The data providing method of claim 17, wherein the storage server further comprises a connection interface for connecting an external electronic apparatus which proposes a data purchase request corresponding to the historical data of the first user, and the data providing method further comprises:
verifying, by the storage server, the data stream on the public blockchain according to the historical data of the first user corresponding to the data purchase request and the hash operation to confirm that the historical data of the first user has not been modified.

19. The data providing method of claim 18, wherein the data providing method further comprises:
transmitting, by the storage server when receiving the data purchase request, the data purchase request to the electronic apparatus corresponding to the first user,
receiving, by the electronic apparatus corresponding to the first user, a message indicating whether the first user agrees to the data purchase request, and transmitting the message to the storage server.

20. The data providing method of claim 18, wherein the data providing method further comprises the following step performed by performed by the main electronic apparatus:
performing a data de-identification processing on the historical data corresponding to the first user, and providing the de-identified data to the external electronic apparatus.
